(19) United States
(12) Patent Application Publication
(10) Pub. No.: US 2017/0364138 A1
(43) Pub. Date: Dec. 21, 2017

(54) IN-VEHICLE COMPUTING SYSTEM WITH POWER CONSERVING MAINTENANCE TASKS

(71) Applicant: Google Inc., Mountain View, CA (US)

(72) Inventors: Yao Chen, Fremont, CA (US); Keun young Park, Santa Clara, CA (US)

(21) Appl. No.: 15/392,694

(22) Filed: Dec. 28, 2016

Related U.S. Application Data
(60) Provisional application No. 62/352,456, filed on Jun. 20, 2016.

(51) Int. Cl. G06F 1/32; B60R 16/023

(52) U.S. Cl. CPC G06F 1/3287; B60R 16/0236

(57) ABSTRACT

In one example, a method includes, transitioning, by an in-vehicle computing system and responsive to determining that a vehicle that includes the in-vehicle computing system is idle, into a maintenance mode during which the in-vehicle computing system is not likely to be accessed by an occupant of the vehicle; while operating in the maintenance mode, performing, by the in-vehicle computing system, one or more maintenance tasks; in response to determining that no maintenance tasks are scheduled or that performance of the one or more maintenance tasks are complete, transitioning, by the in-vehicle computing system, into a low-power mode, wherein the in-vehicle computing system consumes a greater amount of power when operating in the maintenance mode than when operating in the low-power mode; and periodically transitioning, by the in-vehicle computing system and from the low-power mode, into the maintenance mode to determine whether any new maintenance tasks are available.

This application claims the benefit of U.S. Provisional Application No. 62/352,456, filed Jun. 20, 2016, the entire contents of which is incorporated by reference herein.

### BACKGROUND

Vehicles, such as automobiles, motorcycles, aircraft, and watercraft, may include one or more vehicle computing systems for performing functions, controlling vehicle operations, and providing occupants of the vehicle with information, entertainment, assistance, or environmental controls. For instance, an automobile may include an entertainment system for playing music, videos, or other content, a navigation system for providing information and navigational assistance, a temperature control system for heating or cooling the in-vehicle cabin, a control system for adjusting various components or features of the car, such as a sun roof or window shades, or an in-vehicle infotainment (IVI) system that performs some or all of these aforesaid functions. From time to time, a vehicle computing system may need to interrupt regular operations and perform one or more maintenance tasks. For instance, the computing system may perform one or more software updates to applications and platforms executing at the system.

### SUMMARY

In general, this disclosure is directed to techniques for enabling an in-vehicle computing system to perform maintenance tasks without degrading a user experience. For example, instead of performing maintenance tasks (e.g., software updates, map downloads, media library synchronization) when the vehicle is being used, an in-vehicle computing system of the vehicle may perform the maintenance tasks while the vehicle is idle, thereby enabling full use of system resources of the in-vehicle computing system for performing non-maintenance tasks while the vehicle is being used. When the vehicle becomes idle, the in-vehicle computing system may transition into a maintenance mode and perform the scheduled maintenance tasks.

In-vehicle computing systems consume power during operation, and, if an in-vehicle computing system consumes too much power performing maintenance tasks while a vehicle is idle, the vehicle may not be able to function when use of the vehicle is desired (e.g., not have enough power to start in the case of vehicles with electric starters, or have significantly reduced range in the case of electrically driven vehicles). As such, it is desirable for an in-vehicle computing system of a vehicle to minimize the amount of power consumed while the vehicle is idle. Additionally, some maintenance tasks, such as software updates, may not be available before the vehicle becomes idle and it may be desirable for the in-vehicle computing system to perform the new maintenance tasks before the vehicle is next used. However, the in-vehicle computing system may not be able to determine that the new maintenance tasks exist while operating in the low-power mode.

In accordance with one or more techniques of this disclosure, an in-vehicle computing system of a vehicle may periodically transition from the low-power mode to the maintenance mode to determine whether any new maintenance tasks are available. The in-vehicle computing system may then perform the new maintenance tasks before transitioning back into the low-power mode. In this way, the in-vehicle computing system may reduce the amount of power consumed while the vehicle is idle while also performing new maintenance tasks without undue delay.

In one example, a method includes responsive to determining that a vehicle that includes the in-vehicle computing system is idle, transitioning, by the in-vehicle computing system, into a maintenance mode during which the in-vehicle computing system is not likely to be accessed by an occupant of the vehicle; while operating in the maintenance mode, performing, by the in-vehicle computing system, one or more maintenance tasks; in response to determining that no maintenance tasks are scheduled or that performance of the one or more maintenance tasks are complete, transitioning, by the in-vehicle computing system, into a low-power mode, wherein the in-vehicle computing system consumes a greater amount of power when operating in the maintenance mode than when operating in the low-power mode; and periodically transitioning, by the in-vehicle computing system and from the low-power mode, into the maintenance mode to determine whether any new maintenance tasks are available.

In another example, a system includes one or more wireless communication units; and one or more processors. In this example, the one or more processors are configured to transition, responsive to determining that a vehicle that includes the in-vehicle computing system is idle, into a maintenance mode during which the in-vehicle computing system is not likely to be accessed by an occupant of the vehicle; perform, while operating in the maintenance mode, one or more maintenance tasks; transition, responsive to determining that no maintenance tasks are scheduled or that performance of the one or more maintenance tasks are complete, into a low-power mode, wherein the in-vehicle computing system consumes a greater amount of power when operating in the maintenance mode than when operating in the low-power mode; and periodically transition, from the low-power mode, into the maintenance mode to determine whether any new maintenance tasks are available.

In another example, an apparatus includes means for, responsive to determining that a vehicle that includes the in-vehicle computing system is idle, transitioning, by the in-vehicle computing system, into a maintenance mode during which the in-vehicle computing system is not likely to be accessed by an occupant of the vehicle; means for, while operating in the maintenance mode, performing, by the in-vehicle computing system, one or more maintenance tasks; means for, in response to determining that no maintenance tasks are scheduled or that performance of the one or more maintenance tasks are complete, transitioning, by the in-vehicle computing system, into a low-power mode, wherein the in-vehicle computing system consumes a greater amount of power when operating in the maintenance mode than when operating in the low-power mode; and means for, periodically transitioning, by the in-vehicle computing system and from the low-power mode, into the maintenance mode to determine whether any new maintenance tasks are available.

In another example, a computer-readable storage medium stores instructions that, when executed, cause one or more processors of an in-vehicle computing system to: transition, responsive to determining that a vehicle that includes the in-vehicle computing system is idle, into a maintenance mode during which the in-vehicle computing system is not likely to be accessed by an occupant of the vehicle; perform, while operating in the maintenance mode, one or more maintenance tasks; transition, responsive to determining that no maintenance tasks are scheduled or that performance of the one or more maintenance tasks are complete, into a low-power mode, wherein the in-vehicle computing system consumes a greater amount of power when operating in the maintenance mode than when operating in the low-power mode; and periodically transition, from the low-power mode, into the maintenance mode to determine whether any new maintenance tasks are available.

### BRIEF DESCRIPTION OF DRAWINGS

FIG. 1 is a conceptual diagram illustrating an interior of a vehicle that includes a vehicle computing system configured to perform one or more maintenance tasks, in accordance with one or more techniques of this disclosure.

FIG. 2 is a block diagram illustrating an example vehicle computing system configured to perform one or more maintenance tasks, in accordance with one or more techniques of this disclosure.

FIG. 3 is a block diagram illustrating example components of a vehicle computing system configured to perform maintenance tasks, in accordance with one or more techniques of this disclosure.

FIG. 4 is a block diagram illustrating an example computing device that outputs graphical content for display at a remote device, in accordance with one or more techniques of the present disclosure.

FIG. 5 is a flow diagram illustrating example operations of a vehicle computing system to perform maintenance tasks, in accordance with one or more techniques of the present disclosure.

### DETAILED DESCRIPTION

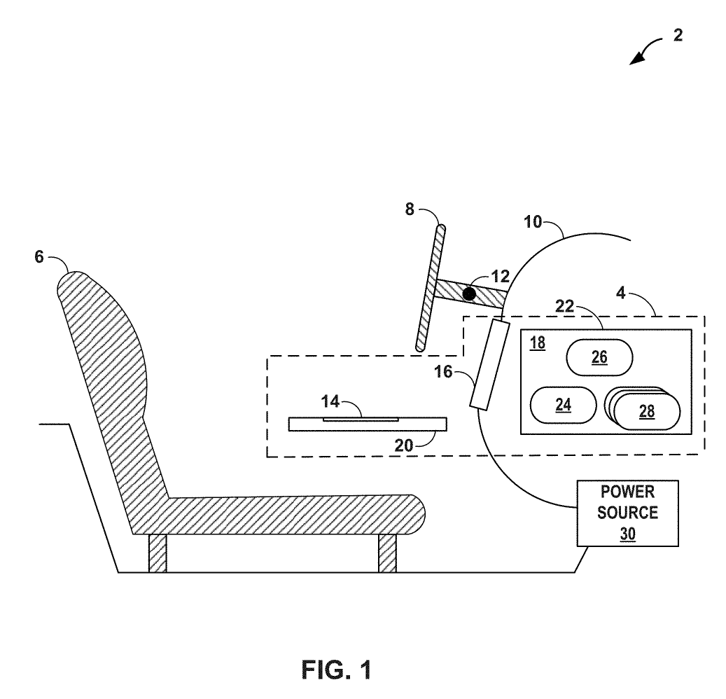

FIG. 1 is a conceptual diagram illustrating an interior of a vehicle that includes a vehicle computing system configured to perform one or more maintenance tasks, in accordance with one or more techniques of this disclosure. As illustrated in FIG. 1, vehicle 2 includes vehicle computing system 4, seat 6, steering wheel 8, dashboard 10, starter control 12, and power source 30.

As illustrated in FIG. 1, vehicle 2 may be an automobile, but aspects of the present disclosure may also be applicable to other types of vehicles, including trucks, motorcycles, aircraft, watercraft, trains, or other vehicles. In FIG. 1, a driver may normally occupy seat 6. Seat 6 of the automobile may be positioned directly behind steering wheel 8 of vehicle 2 such that an occupant of seat 6 may physically control steering wheel 8. Steering wheel 8 may protrude from dashboard 10. At least one front passenger seat may be laterally positioned adjacent to seat 6. Other passenger seats may be positioned behind seat 6 or in front of seat 6. Vehicle 2 may also include starter control 12 (e.g., an ignition of vehicle 2, whether keyed or keyless), which may be positioned on dashboard 10, steering wheel 8, or other suitable location within reach of an occupant of seat 6.

Vehicle 2 may include power source 30, which may be configured to provide power to one or more components of vehicle 2, such as vehicle computing system 4 and one or more other devices of vehicle 2. As one example, in addition to vehicle computing system 4, power source 30 may be configured to provide electrical power to a starter of an internal-combustion engine of vehicle 2. As another example, in addition to vehicle computing system 4, power source 30 may be configured to provide power to one or more electric drive motors of vehicle 2 or a hybrid engine and electric drive motor propulsion system of vehicle 2. Examples of power source 30 include, but are not necessarily limited to, batteries, fuel-cells, or any other power source capable of providing power. Examples of batteries that may be included in power source 30 may include, but are not necessarily limited to, batteries having zinc-carbon, lead-acid, nickel cadmium (NiCd), nickel metal hydride (NiMH), lithium ion (Li-ion), and/or lithium ion polymer (Li-ion polymer) chemistries. In some examples, power source 30 may have a limited capacity (e.g., 30-100 Amp-Hours).

Also shown in FIG. 1 is a collection of devices, components, and modules that may each be included in vehicle computing system 4. Vehicle computing system 4 includes, but is not limited to, presence-sensitive panel 14, display 16 and control unit 18. One or more components of vehicle computing system 4, such as presence-sensitive panel 14 may be directly and physically accessible to occupants seated in the front driver and front passenger seats of vehicle 2, and may be located within, near, or on center console 20. Such components may be within easy reach of such occupants, and may also or alternatively be positioned in another passenger area of vehicle 2, such as a back seat. As further described below, presence-sensitive panel 14 may function as an input device for vehicle computing system 4. In some examples, presence-sensitive panel 14 may be integrated into display 16 such that display 16 may be a presence-sensitive display. In some examples, one or more components of vehicle computing system 4 that may not necessarily require physical access by occupants of vehicle 2 (such as, in some examples, display 16 and control unit 18), may be positioned in or on or integrated into dashboard 10.

As described and illustrated, some or all of vehicle computing system 4 may be housed within dashboard 10, which may in some examples be constructed of plastic, vinyl, leather, rubber, aluminum, steel, or any other suitable material. Control unit 18 may be housed within housing 22, which may also be constructed of plastic, vinyl, rubber, aluminum, steel, or any other suitable material. In some examples, housing 22 may also be a rigid case that encloses and otherwise protects one or more electrical components that provide functionality for vehicle computing system 4. In some examples, housing 22 may be affixed, mounted or otherwise integrated with the automobile dashboard or console.

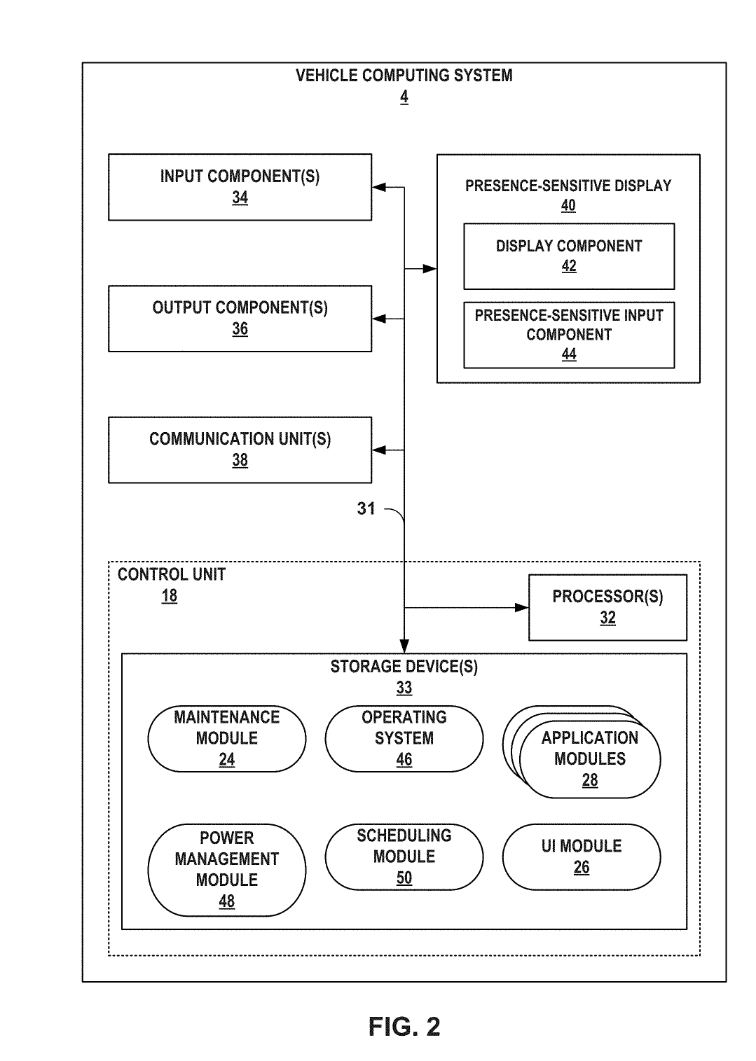

Control unit 18 may provide an operating environment or platform for one or one more modules, such as a combination of hardware, firmware, and software, as further illustrated in FIG. 2. For instance, control unit 18 may include one or more processors and storage devices that may execute instructions and store data of one or more modules. Control unit 18 may also be operably coupled to one or more other software and/or hardware components, including presence-sensitive panel 14, and display 16 to control, configure, and/or communicate information with the components, to name only a few example operations.

Vehicle computing system 4 may operate to assist, inform, entertain, or perform other tasks that require user interactions with occupants of a vehicle. Vehicle computing system 4 may be referred to as an in-vehicle infotainment (IVI) system, or a subcomponent thereof. For example, vehicle computing system 4 may include one or more application modules 4 that perform functions or process information on behalf of one or more occupants of vehicle 2. For instance, vehicle computing system 4 may provide a navigation service that provides directions to destinations. Vehicle computing system 4 may also provide an information retrieval service that provides information in response to queries and/or as preemptive assistance or recommendations. Vehicle computing system 4 may also provide vehicle data about vehicle 2, or multimedia such as audio or video. Mentioned are only a few examples of the functionality that may be provided by vehicle computing system 4, and vehicle computing system 4 may provide many additional capabilities. In this and other ways, vehicle computing system 4 may improve the driving or riding experience for one or more occupants of vehicle 2.

In some examples, vehicle computing system 4 may be controlled through input detected by presence-sensitive panel 14. Vehicle computing system 4 may also be controlled through input detected by one or more additional input devices (e.g., microphones, physical buttons or switches, or other types of input devices).

Presence-sensitive panel 14 may, in some examples, function simply as an input device for touch input, provided by user input that occurs directly and physically at presence-sensitive panel 14. For instance, presence-sensitive panel 14 may function as a presence-sensitive input device using a presence-sensitive device, such as a resistive touchscreen or touch panel, a surface acoustic wave touchscreen or touch panel, a capacitive touchscreen or touch panel, a projective capacitance touchscreen or touch panel, a pressure-sensitive screen or touch panel, an acoustic pulse recognition touchscreen or touch panel, or another presence-sensitive screen or touch panel technology.

Display 16 may function as an output device, such as a display device, using any one or more of a liquid crystal display (LCD), dot matrix display, light emitting diode (LED) display, organic light-emitting diode (OLED) display, e-ink, or similar monochrome or color display capable of outputting visible information to a user or vehicle occupant. In some examples, display 16 may also function as an input device, so that it serves as both an input and output device. In such examples, display 16 may include an integrated presence-sensitive input device and a display device. For instance, display 16 may function as a presence-sensitive input device using a presence-sensitive screen, such as a resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology. Based on user input, display 16 may present output to a user. For instance, display 16 may present various user interfaces of applications (e.g., a navigation application) executing at vehicle computing system 4. An occupant of the vehicle, such as a driver, may provide user input to interact with one or more of such applications.

As described above, vehicle computing system 4 may include maintenance module 24, user interface (UI) module 26 and application modules 28. Maintenance module 24, UI module 26 and application modules 28 may perform operations described herein using software, hardware, firmware, or a mixture of both hardware, software, and firmware residing in and executing by vehicle computing system 4 or at one or more other remote computing devices. As such, maintenance module 24, UI module 26, and application modules 28 may be implemented as hardware, software, and/or a combination of hardware and software. Vehicle computing system 4 may execute maintenance module 24, UI module 26, application modules 28, or one or more other modules as or within a virtual machine executing on underlying hardware. Maintenance module 24, UI module 26, and application modules 28 may be implemented in various ways. For example, maintenance module 24, UI module 26, and application modules 28 may be implemented as a downloadable or pre-installed application or “app.” In another example, maintenance module 24, UI module 26, and application modules 28 may be implemented as part of an operating system of vehicle computing system 4.

Application modules 28 may include functionality to perform any variety of operations on vehicle computing system 4. For instance, application modules 28 may include a navigation application, weather application, a phone dialer application, an information retrieval application, a multimedia application, a vehicle information application, an email application, a text messing application, instant messaging application, social networking application, weather application, stock market application, emergency alert application, sports application, to name only a few examples. Although shown as operable within control unit 18 of vehicle computing system 4, one or more of application modules 28 may be operable by a remote computing device that is communicatively coupled to vehicle computing system 4. In such examples, an application module executing at a remote computing device may cause the remote computing device to send the content and intent information using any suitable form of data communication (e.g., wired or wireless network, short-range wireless communication such as Near Field Communication or Bluetooth, etc.). In some examples, a remote computing device may be a computing device that is separate from a computing device included in vehicle computing system 4. For instance, the remote computing device may be operatively coupled to vehicle computing system 4 by a network. Examples of a remote computing device may include, but is not limited to a server, smartphone, tablet computing device, smart watch, and desktop computer. In some examples, a remote computing device may or may not be an integrated component of vehicle computing system 4.

UI module 26 of vehicle computing system 4 may receive from presence-sensitive panel 102 one or more indications of user input detected at presence-sensitive panel 14. Generally, each time presence-sensitive panel 14 detects user input at a particular location of presence-sensitive panel 14, UI module 26 may receive an indication of user input or information about the user input from presence-sensitive panel 14. UI module 26 may assemble the information received from presence-sensitive panel 14 into a set of one or more events, such as a sequence of one or more touch events. Each touch event in the sequence may include data or components that represent parameters (e.g., when, where, originating direction) characterizing a presence and/or movement of input at presence-sensitive panel 14. Each touch event in the sequence may include a location component corresponding to a location of presence-sensitive panel 14, a time component related to when presence-sensitive panel 14 detected user input at the location, and/or an action component related to whether the touch event corresponds to a lift up or a push down at the location.

UI module 26 may determine one or more characteristics of the user input based on the sequence of touch events and include information about these one or more characteristics within each touch event in the sequence of touch events. For example, UI module 26 may determine a start location of the user input, an end location of the user input, a density of a portion of the user input, a speed of a portion of the user input, a direction of a portion of the user input, and a curvature of a portion of the user input. UI module 26 may transmit indications of user input from presence-sensitive panel 14 to other modules, such as application modules 28. UI module 26 may determine one or more single- or multi-touch gestures provided by a user. UI module 26 may also act as an intermediary between various components of vehicle computing system 4 to make determinations based on input detected by presence-sensitive panel 14 and generate output presented by display 16. For instance, UI module 26 may receive data from one or more application modules 28 and cause display 16 to output content, such as a graphical user interface, for display.

Maintenance module 24 may include functionality to perform one or more maintenance tasks on components of vehicle computing system 4. Some example maintenance tasks that may be performed by maintenance module 24 include, but are not necessarily limited to, updating a firmware or a software of one or more components of vehicle computing system 4, and synchronizing one or more media libraries for use by one or more components of vehicle computing system 4. Maintenance module 24 may receive maintenance tasks to be performed from a wide variety of sources. As one example, maintenance module 24 may receive, via a wireless communication link of vehicle 2, an indication of a new maintenance task. For instance, maintenance module 24 may receive an indication that a new version of a navigation application module of application modules 28 is available. As another example, maintenance module 23 may receive an indication of a new maintenance task from an application of application modules 28. For instance, maintenance module 24 may receive an indication from a navigation application module of application modules 28 that an updated map is available.

In general, it may be desirable to avoid performing maintenance tasks while vehicle 2 is being used (e.g., being driven, parked yet receiving user inputs, or otherwise occupied and/or being used). For instance, the performance of some maintenance tasks while vehicle 2 is being used may without degrade system responsiveness and any may cause driver distraction. As such, while vehicle 2 is being used, maintenance module 24 may schedule one or more maintenance tasks to be performed when vehicle 2 becomes idle (i.e., parked and unoccupied). For instance, in response to receiving the indication that the new version of the navigation application module is available, maintenance module 24 may schedule installation of the new version of the navigation application module when vehicle 2 becomes idle.

In response to determining that vehicle 2 is idle, maintenance module 24 may cause vehicle computing system 4 to transition from a standard mode into a maintenance mode, which may be referred to as a garage mode. Maintenance module 24 may determine that vehicle 2 has become idle based on one or more signals received from other components of vehicle 2. Some example signals which maintenance module 24 may use to determine whether vehicle 2 is idle include, but are not necessarily limited to, whether vehicle 2 is set to park, whether a display of vehicle computing system 4 (e.g., display 16) is off, whether starter control 12 is set to off, and whether an occupancy sensor of seat 6 indicates that seat 6 is occupied.

While vehicle computing system 4 is operating in the maintenance mode, maintenance module 24 may perform one or more scheduled maintenance tasks. For instance, while operating in the maintenance mode, maintenance module 24 may facilitate installation of the new version of the navigation application module.

Vehicle computing system 4 may consume power from power source 30 while operating in the maintenance mode and, if vehicle computing system 4 consumes too much while vehicle 2 is idle, power source 30 may not have enough power to enable functionality of one or more components of vehicle 2 when use of vehicle 2 is next desired. As one example, where vehicle 2 includes an electric starter configured to start an internal-combustion engine, power supply 30 may not have enough power to operate the electric starter. As another example, where vehicle 2 includes one or more electric drive motors, a distance for-which power supply 30 may enable vehicle 2 to travel using the electric drive motors may be significantly reduced or may be zero. As such, it is desirable for maintenance module 24 to minimize the amount of power consumed while the vehicle is idle.

In accordance with one or more techniques of this disclosure, maintenance module 24 may cause vehicle computing system 4 to transition from the maintenance mode into a low-power mode after performing (or causing to be performed) one or more scheduled maintenance tasks while vehicle 2 is idle. As vehicle computing system 4 may consume less power from power supply 30 when operating in the low-power mode than when operating in the maintenance mode, vehicle computing system 4 may reduce the amount of power consumed while vehicle 2 is idle.

Some maintenance tasks may not be available before vehicle 2 becomes idle and it may be desirable for maintenance module 24 to perform the new maintenance tasks before vehicle 2 is next used. However, while vehicle computing system 4 is operating in the low-power mode, maintenance module 24 may not be able to determine that the new maintenance tasks exist. For instance, while vehicle computing system 4 is operating in the low-power mode, maintenance module 24 may not be able to receive an indication that a new version of a music streaming application of application modules 28 has become available.

In accordance with one or more techniques of this disclosure, vehicle computing system 4 may periodically transition from the low-power mode to the maintenance mode to enable maintenance module 24 to determine whether any new maintenance tasks are available. While vehicle computing system 4 is operating in the maintenance mode, maintenance module 24 may perform the new maintenance tasks and/or cause the new maintenance tasks to be performed. As one example, maintenance module 24 may receive an indication that the new version of the music streaming application has become available, download and facilitate installation of the new version. As another example, maintenance module 24 may cause a navigation application of application modules 28 to download new maps.

When maintenance module 24 has completed performing the new maintenance tasks, or if there are no new maintenance tasks, maintenance module 24 may cause vehicle computing system 4 to transitioning back into the low-power mode. In this way, maintenance module 24 may reduce the amount of power consumed while vehicle 2 is idle while also performing new maintenance tasks such that the new maintenance tasks may be completed before vehicle 2 is next used.

Though periodically transitioning between the low-power mode and the maintenance mode may reduce the amount of power consumed by vehicle computing system 4, it may be desirable to further reduce the power consumption. For instance, if vehicle 2 is idle for an extended period of time (a week, a month, a year, etc.), the amount of power consumed by vehicle computing system 4 while periodically operating in the maintenance mode may still cause power source 30 to not have enough power to enable functionality of one or more components of vehicle 2 when use of vehicle 2 is next desired.

In accordance with one or more techniques of this disclosure, as opposed to periodically transitioning between the low-power mode and the maintenance mode at a constant interval, vehicle computing system 4 may periodically transition between the low-power mode and the maintenance mode at an increasing interval. For instance, during a first period of time that vehicle 2 is idle (e.g., one week), vehicle computing system 4 may periodically transition between the low-power mode and the maintenance mode at a first interval (e.g., daily). During a second period of time that vehicle 2 is idle (e.g., one month), vehicle computing system 4 may periodically transition between the low-power mode and the maintenance mode at a second interval that is longer than the first interval (e.g., weekly). In some cases, after vehicle 2 has been idle for a long enough period of time, vehicle computing system 4 may cease transitioning between the low-power mode and the maintenance mode and may remain in the low-power mode until vehicle 2 is no longer idle. In this way, vehicle computing system 4 may reduce the amount of power consumed while vehicle 2 is idle while also performing new maintenance tasks without undue delay and increasing the likelihood that power supply 30 will have enough power to enable functionality of one or more components of vehicle 2 when use of vehicle 2 is next desired.

As discussed above, vehicle computing system 4 may periodically transition from the low-power mode to the maintenance mode to enable maintenance module 24 to determine whether any new maintenance tasks are available. As also discussed above, vehicle computing system 4 may transition from the low-power mode to the maintenance mode based on a timer/periodic interrupt (i.e., a timer and/or periodic interrupt set based on the interval). However, while some computing systems may transition from low-power modes based on other events (e.g., voice commands, motions, alarms), in some examples, it may be desirable for vehicle computing system 4 to avoid transitioning from the low-power mode to the maintenance mode from such other events. As such, in some examples, it may be desirable for vehicle computing system 4 to periodically transition from the low-power mode to the maintenance mode based on the timer, without influence by other events.

FIG. 2 is a block diagram illustrating an example vehicle computing system configured to perform one or more maintenance tasks, in accordance with one or more techniques of this disclosure. Vehicle computing system 4 of FIG. 2 is described below within the context of FIG. 1. FIG. 2 illustrates only one particular example of vehicle computing system 4, and many other examples of vehicle computing system 4 may be used in other instances and may include a subset of the components shown in FIG. 2 or may include additional components not shown in FIG. 2.

As shown in the example of FIG. 2, vehicle computing system 4 includes one or more input components 34, one or more output components 36, one or more communication units 38, and presence-sensitive display 40, and control unit 18 that include one or more processors 32, and one or more storage devices 33. Storage devices 33 of control unit 18 may also include maintenance module 24, UI module 26, application modules 28, operating system 46, power management module 48, and scheduling module 50. Communication channels 31 may interconnect one or more of the components 24, 26, 28, 32, 33, 34, 36, 38, 40, 46, 48, and 50 for inter-component communications (physically, communicatively, and/or operatively). In some examples, communication channels 31 may include a system bus, a network connection, one or more inter-process communication data structures, or any other components for communicating data between hardware and/or software.

As shown in FIG. 2, control unit 18 may store and execute the data and instructions of one or more applications, modules or other software. Although FIG. 2 illustrates control unit 18 as including one or more processors 218 and one or more storages device 220, control unit 18 may include more or fewer components than shown in FIG. 2. For instance, control unit 18 may include one or more output devices, input devices, input/output ports or interface, sensors and/or communication units to name only a few examples. In other examples, control unit 18 may only include one or more processors. In any case, control unit 18 may provide an operating environment for one or one more modules, such as maintenance module 24, user-interface (UI) module 26, application modules 28, operating system 46, power management module 48, and scheduling module 50.

One or more processors 32 may implement functionality and/or execute instructions within vehicle computing system 4. For example, processors 32 of control unit 18 may receive and execute instructions stored by storage devices 33 that provide the functionality of maintenance module 24, UI module 26, application modules 28, operating system 46, power management module 48, and scheduling module 50. These instructions executed by processors 32 may cause vehicle computing system 4 to store and/or modify information, within storage devices 33 during program execution. Processors 32 may execute instructions of maintenance module 24, UI module 26, application modules 28, operating system 46, power management module 48, and scheduling module 50 to perform one or more operations. That is, maintenance module 24, UI module 26, application modules 28, operating system 46, power management module 48, and scheduling module 50 may be operable by processors 32 to perform various functions described herein.

One or more input components 34 of vehicle computing system 4 may receive input. Examples of input are tactile, audio, and video input. In some examples, input components 34 may include functionality of presence-sensitive panel 14 of FIG. 1. Input components 34 of vehicle computing system 4, in one example, includes a presence-sensitive input device (e.g., a touch sensitive screen, a presence-sensitive display), mouse, keyboard, buttons, switches, voice responsive system, video camera, microphone or any other type of device for detecting input from a human or machine. In some examples, input components 34 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output devices 36 of vehicle computing system 4 may generate output. Examples of output are tactile, audio, and video output. In some examples, output components 36 may include functionality of display 16 of FIG. 1. Output devices 36 of vehicle computing system 4, in one example, include a presence-sensitive screen, sound card, video graphics adapter card, speaker, cathode ray tube (CRT) monitor, liquid crystal display (LCD), or any other type of device for generating output to a human or machine. Output devices 36 may include display devices such as cathode ray tube (CRT) monitor, liquid crystal display (LCD), Light-Emitting Diode (LED) or any other type of device for generating tactile, audio, and/or visual output.

One or more communication units 38 of vehicle computing system 4 may communicate with external devices by transmitting and/or receiving data. For example, vehicle computing system 4 may use communication units 38 to transmit and/or receive radio signals on a radio network such as a cellular radio network. In some examples, communication units 38 may transmit and/or receive satellite signals on a satellite network such as a Global Positioning System (GPS) network or a Global Navigation Satellite System (GLONASS) network. Examples of communication units 38 include a network interface card (e.g. such as an Ethernet card), an optical transceiver, a radio frequency transceiver, a GPS receiver, or any other type of device that can send and/or receive information. Other examples of communication units 38 may include Bluetooth®, GPS, 3G, 4G, and Wi-Fi® radios found in mobile devices as well as Universal Serial Bus (USB) controllers and the like.

In some examples, presence-sensitive display 40 of vehicle computing system 4 may include functionality of input components 34 and/or output components 36. In the example of FIG. 2, presence-sensitive display 40 may include a presence-sensitive input component 44, such as a presence-sensitive screen or touch-sensitive screen. In some examples, presence-sensitive input component 44 may detect an object at and/or near the presence-sensitive input device. As one example range, presence-sensitive input component 44 may detect an object, such as a finger or stylus that is within two inches or less of presence-sensitive input component 44. Presence-sensitive input component 44 may determine a location (e.g., an (x,y) coordinate) of the presence-sensitive input device at which the object was detected. In another example range, presence-sensitive input component 44 may detect an object six inches or less from presence-sensitive input component 44 and other ranges are also possible. Presence-sensitive input component 44 may determine the location of presence-sensitive input component 44 selected by a user's finger using capacitive, inductive, and/or optical recognition techniques.

In some examples, presence-sensitive display 40 may also provide output to a user using tactile, audio, or video stimuli as described with respect to output components 36. For instance, presence-sensitive display 40 may include display component 42 that presents a graphical user interface. Display component 42 may be any type of output device that provides visual output, such as described with respect to output components 36. Presence-sensitive display 40 may, in some examples, be an external component that shares a data path with other components of vehicle computing system 4 for transmitting and/or receiving input and output. For instance, presence-sensitive display 40 may be a built-in component of a head-unit that includes control unit 18, such as housing 22 of FIG. 1, located within and physically connected to the external packaging of control unit 18. In another example, presence-sensitive display 40 may be an external component of control unit 18 located outside and physically separated from the packaging of control unit 18 (e.g., a monitor, a projector, etc. that shares a wired and/or wireless data path with a tablet computer).

One or more storage devices 33 within vehicle computing system 4 may store information for processing during operation of vehicle computing system 4. In some examples, one or more of storage devices 33 are temporary memories, meaning that a primary purpose of the one or more storage devices is not long-term storage. Storage devices 33 on vehicle computing system 4 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 33, in some examples, also include one or more computer-readable storage media. Storage devices 33 may be configured to store larger amounts of information than volatile memory. Storage devices 33 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 33 may store program instructions and/or data associated with maintenance module 24, UI module 26, application modules 28, operating system 46, power management module 48, and scheduling module 50.

Operating system 46, in some examples, controls the operation of components of vehicle computing system 4. For example, operating system 46, in one example, facilitates the communication of maintenance module 24, UI module 26, application modules 28, power management module 48, and scheduling module 50 with processors 32, storage devices 33, input components 34, output components 36, communication units 38, presence-sensitive display 40.

Power management module 48 may be configured to control a power state of one or more components of vehicle computing system 2. As one example, based on a signal from an electronic control unit (ECU) of vehicle 2 indicating that vehicle 2 is being used, power management module 48 may cause one or more components of vehicle computing system 4 to operate in a standard mode. As another example, based on a signal received from maintenance module 24, power management module 48 may cause one or more components of vehicle computing system 4 to operate in a maintenance mode or a low-power mode.

Scheduling module 50 may be configured to schedule performance of one or more tasks by vehicle computing system 4. In some examples, one or more of the scheduled tasks may have one or more performance requirements. For instance, in order to be performed, a particular scheduled task may require that vehicle 2 is idle and connected to an un-metered network connection (i.e., a network connection where use of the network is not sold based on an amount of bandwidth consumed).

As discussed above, maintenance module 24 may perform one or more maintenance tasks on components of vehicle computing system 4. In some examples, performance of the maintenance tasks by maintenance module 24 may involve downloading data from one or more external systems via a wireless link of communication units 38. In some examples, maintenance module 24 may be configured to cause communication units 38 to use a particular wireless connection (e.g., WiFi network) to download the data. As one example, maintenance module 24 may be configured to cause communication units 38 to use a particular wireless connection designated by a user of vehicle computing system 4 for use by vehicle computing system 4 (i.e., the user may designate a network for vehicle computing system 4 to use when downloading data for maintenance tasks). As another example, maintenance module 24 may be configured to cause communication units 38 to use a particular wireless connection designated by a user of vehicle computing system 4 for use by a mobile computing device (e.g., a phone, tablet, laptop) of the user (i.e., maintenance module 24 may use network preferences from a different device of the user when downloading data for maintenance tasks). As another example, maintenance module 24 may be configured to cause communication units 38 to use a particular wireless connection designated by a user of vehicle computing system 4 as a home wireless network or a work wireless network in an account of the user. In some of such examples, maintenance module 24 may obtain one or more credentials, such as a user name and/or a password, from the account of the user.

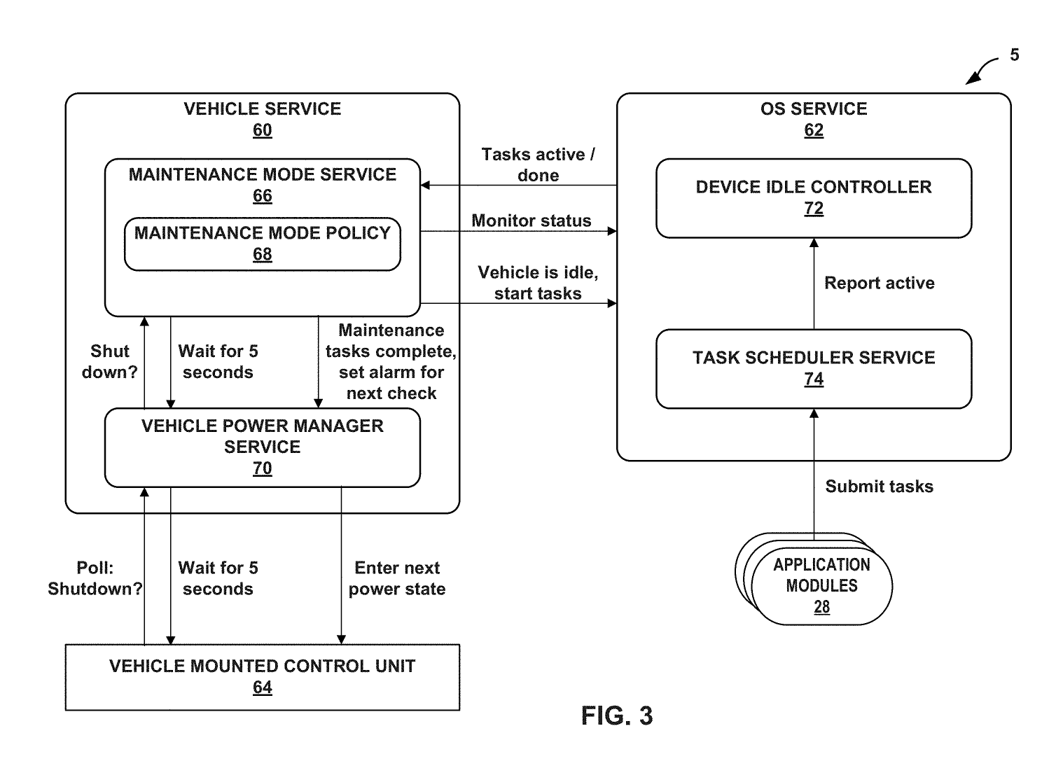

FIG. 3 is a block diagram illustrating example components of a vehicle computing system configured to perform maintenance tasks, in accordance with one or more techniques of this disclosure. As illustrated in FIG. 3, vehicle computing system 5 includes vehicle service 60, operating system (OS) service 62, vehicle mounted control unit 64, and application modules 66. Vehicle computing system 5 may include functionality similar to vehicle computing system 4 of FIG. 1 and FIG. 2. For instance, vehicle computing system 5 may be configured to perform one or maintenance tasks (i.e., maintenance jobs) on a vehicle.

Vehicle service 60 may include maintenance mode service 66 and vehicle power manager service 70. As shown in FIG. 3, vehicle power manager service 70 may query maintenance mode service 66 to determine whether vehicle computing system 5 may transition into a lower-power operating mode (i.e., “Shut down?”). If one or more maintenance tasks are currently being performed, maintenance mode service 66 may respond that vehicle computing system 5 may not transition into the lower-power operating mode. Similarly, if one or more maintenance tasks are not currently being performed, maintenance mode service 66 may respond that vehicle computing system 5 may transition into the lower-power operating mode and set an alarm to wake up and repeat the check in process (i.e., “Maintenance tasks complete, set alarm for next check”). As discussed in more detail below, in some examples, maintenance mode service 66 adjust a length of the alarm based on maintenance mode policy such that the length of the alarm increases over time.

OS service 62 may include device idle controller 72 and task scheduler service 74. Task scheduler service 74 may receive requests to perform maintenance tasks from application modules 28. In response to determining that a vehicle that includes vehicle computing system 5 is idle, maintenance mode service 66 may output an indication to OS service 62 that any maintenance tasks that require the vehicle to be idle may be performed (i.e., “Vehicle is idle, start tasks”). As discussed above, maintenance mode service 66 may prevent vehicle computing system 5 from transitioning into the lower-power operating mode if one or more maintenance tasks are currently being performed. As shown in FIG. 3, maintenance mode service 66 may monitor a status of OS service 62 to determine whether the one or more maintenance tasks are currently being performed.

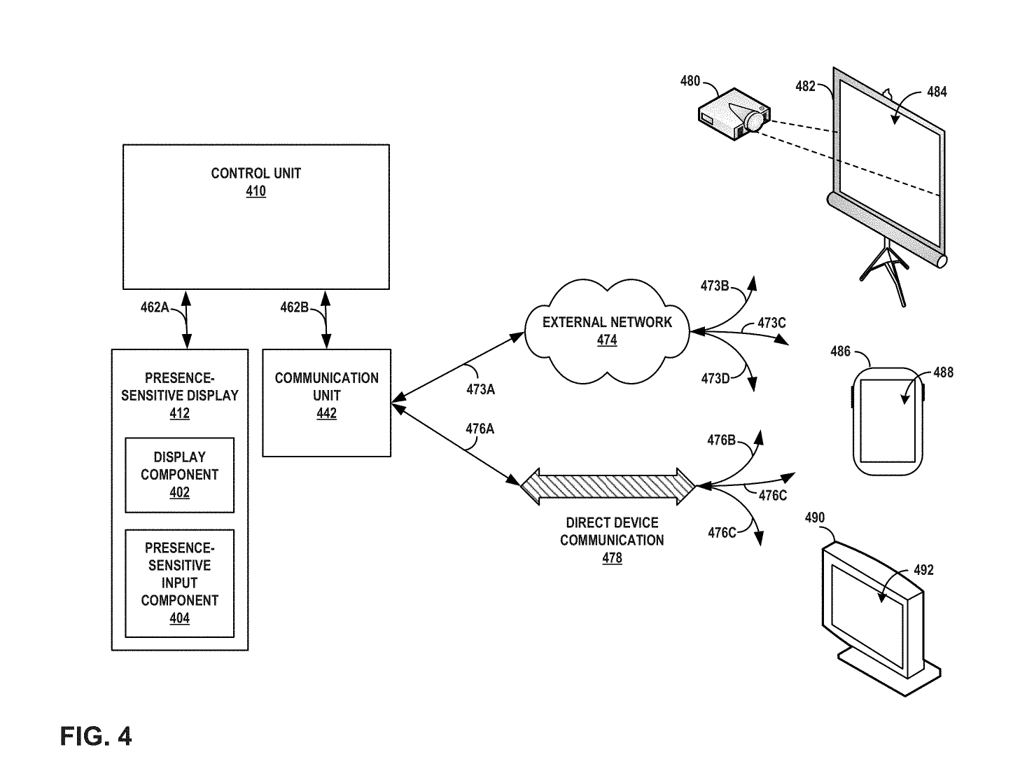

FIG. 4 is a block diagram illustrating an example computing device that outputs graphical content for display at a remote device, in accordance with one or more techniques of the present disclosure. Graphical content, generally, may include any visual information that may be output for display, such as text, images, or a group of moving images, to name only a few examples. The example shown in FIG. 4 includes a computing device 410, a PSD 412, communication unit 442, projector 480, projector screen 482, mobile device 486, and visual display component 490. In some examples, PSD 412 may be a presence-sensitive display as described in FIGS. 1-2. Although shown for purposes of example in FIGS. 1 and 2 as a stand-alone control unit 18, a computing device such as control unit 410 may, generally, be any component or system that includes a processor or other suitable computing environment for executing software instructions and, for example, need not include a presence-sensitive display.

As shown in the example of FIG. 4, control unit 410 may be a processor that includes functionality as described with respect to processors 240 in FIG. 2. In such examples, control unit 410 may be operatively coupled to PSD 412 by a communication channel 462A, which may be a system bus or other suitable connection. Control unit 410 may also be operatively coupled to communication unit 442, further described below, by a communication channel 462B, which may also be a system bus or other suitable connection. Although shown separately as an example in FIG. 4, control unit 410 may be operatively coupled to PSD 412 and communication unit 442 by any number of one or more communication channels.

In other examples, such as illustrated previously by computing device 110 in FIGS. 1A-1E or computing device 210 in FIG. 2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 412 may include display component 402 and presence-sensitive input component 404. Display component 402 may, for example, receive data from control unit 410 and display the graphical content. In some examples, presence-sensitive input component 404 may determine one or more user inputs (e.g., continuous gestures, multi-touch gestures, single-touch gestures) at PSD 412 using capacitive, inductive, and/or optical recognition techniques and send indications of such user input to control unit 410 using communication channel 462A. In some examples, presence-sensitive input component 404 may be physically positioned on top of display component 402 such that, when a user positions an input unit over a graphical element displayed by display component 402, the location at which presence-sensitive input component 404 corresponds to the location of display component 402 at which the graphical element is displayed.

As shown in FIG. 4, control unit 410 may also include and/or be operatively coupled with communication unit 442. Communication unit 442 may include functionality of communication unit 242 as described in FIG. 2. Examples of communication unit 442 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Control unit 410 may also include and/or be operatively coupled with one or more other devices (e.g., input devices, output components, memory, storage devices) that are not shown in FIG. 4 for purposes of brevity and illustration.

FIG. 4 also illustrates a projector 480 and projector screen 482. Other such examples of projection devices may include electronic whiteboards, holographic display components, and any other suitable devices for displaying graphical content. Projector 480 and projector screen 482 may include one or more communication units that enable the respective devices to communicate with control unit 410. In some examples, the one or more communication units may enable communication between projector 480 and projector screen 482. Projector 480 may receive data from control unit 410 that includes graphical content. Projector 480, in response to receiving the data, may project the graphical content onto projector screen 482. In some examples, projector 480 may determine one or more user inputs (e.g., continuous gestures, multi-touch gestures, single-touch gestures) at projector screen using optical recognition or other suitable techniques and send indications of such user input using one or more communication units to control unit 410. In such examples, projector screen 482 may be unnecessary, and projector 480 may project graphical content on any suitable medium and detect one or more user inputs using optical recognition or other such suitable techniques.

Projector screen 482, in some examples, may include a presence-sensitive display 484. Presence-sensitive display 484 may include a subset of functionality or all of the functionality of presence-sensitive display 112 and/or 412 as described in this disclosure. In some examples, presence-sensitive display 484 may include additional functionality. Projector screen 482 (e.g., an electronic whiteboard), may receive data from control unit 410 and display the graphical content. In some examples, presence-sensitive display 484 may determine one or more user inputs (e.g., continuous gestures, multi-touch gestures, single-touch gestures) at projector screen 482 using capacitive, inductive, and/or optical recognition techniques and send indications of such user input using one or more communication units to control unit 410.

FIG. 4 also illustrates mobile device 486 and visual display component 490. Mobile device 486 and visual display component 490 may each include computing and connectivity capabilities. Examples of mobile device 486 may include e-reader devices, convertible notebook devices, hybrid slate devices, etc. Examples of visual display component 490 may include other devices such as televisions, computer monitors, etc. In some examples, visual display component 490 may be a vehicle cockpit display or navigation display (e.g., in an automobile, aircraft, or some other vehicle). In some examples, visual display component 490 may be a home automation display or some other type of display that is separate from control unit 410.

As shown in FIG. 4, mobile device 486 may include a presence-sensitive display 488. Visual display component 490 may include a presence-sensitive display 492. Presence-sensitive displays 488, 492 may include a subset of functionality or all of the functionality of presence-sensitive display 112, 212, and/or 412 as described in this disclosure. In some examples, presence-sensitive displays 488, 492 may include additional functionality. In any case, presence-sensitive display 492, for example, may receive data from control unit 410 and display the graphical content. In some examples, presence-sensitive display 492 may determine one or more user inputs (e.g., continuous gestures, multi-touch gestures, single-touch gestures) at projector screen using capacitive, inductive, and/or optical recognition techniques and send indications of such user input using one or more communication units to control unit 410.

As described above, in some examples, control unit 410 may output graphical content for display at PSD 412 that is coupled to control unit 410 by a system bus or other suitable communication channel. Control unit 410 may also output graphical content for display at one or more remote devices, such as projector 480, projector screen 482, mobile device 486, and visual display component 490. For instance, control unit 410 may execute one or more instructions to generate and/or modify graphical content in accordance with techniques of the present disclosure. Control unit 410 may output the data that includes the graphical content to a communication unit of control unit 410, such as communication unit 442. Communication unit 442 may send the data to one or more of the remote devices, such as projector 480, projector screen 482, mobile device 486, and/or visual display component 490. In this way, control unit 410 may output the graphical content for display at one or more of the remote devices. In some examples, one or more of the remote devices may output the graphical content at a presence-sensitive display that is included in and/or operatively coupled to the respective remote devices.

In some examples, control unit 410 may not output graphical content at PSD 412 that is operatively coupled to control unit 410. In other examples, control unit 410 may output graphical content for display at both a PSD 412 that is coupled to control unit 410 by communication channel 462A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by control unit 410 and output for display at PSD 412 may be different than graphical content display output for display at one or more remote devices.

Control unit 410 may send and receive data using any suitable communication techniques. For example, control unit 410 may be operatively coupled to external network 474 using network link 473A. Each of the remote devices illustrated in FIG. 4 may be operatively coupled to network external network 474 by one of respective network links 473B, 473C, or 473D. External network 474 may include network hubs, network switches, network routers, etc., that are operatively inter-coupled thereby providing for the exchange of information between control unit 410 and the remote devices illustrated in FIG. 4. In some examples, network links 473A-473D may be Ethernet, ATM or other network connections. Such connections may be wireless and/or wired connections.

In some examples, control unit 410 may be operatively coupled to one or more of the remote devices included in FIG. 4 using direct device communication 478. Direct device communication 478 may include communications through which control unit 410 sends and receives data directly with a remote device, using wired or wireless communication. That is, in some examples of direct device communication 478, data sent by control unit 410 may not be forwarded by one or more additional devices before being received at the remote device, and vice-versa. Examples of direct device communication 478 may include Bluetooth, Near-Field Communication, Universal Serial Bus, Wi-Fi, infrared, etc. One or more of the remote devices illustrated in FIG. 4 may be operatively coupled with control unit 410 by communication links 476A-476D. In some examples, communication links 476A-476D may be connections using Bluetooth, Near-Field Communication, Universal Serial Bus, infrared, etc. Such connections may be wireless and/or wired connections.

Control unit 410 may be operatively coupled to visual display component 490 using external network 474. Control unit 410 may output a graphical keyboard for display at PSD 412. For instance, control unit 410 may send data that includes a representation of the graphical keyboard to communication unit 442. Communication unit 442 may send the data that includes the representation of the graphical keyboard to visual display component 490 using external network 474. Visual display component 490, in response to receiving the data using external network 474, may cause PSD 492 to output the graphical keyboard. In response to receiving a user input at PSD 492 to select one or more keys of the keyboard, visual display device 130 may send an indication of the user input to control unit 410 using external network 474. Communication unit 442 of may receive the indication of the user input, and send the indication to control unit 410.

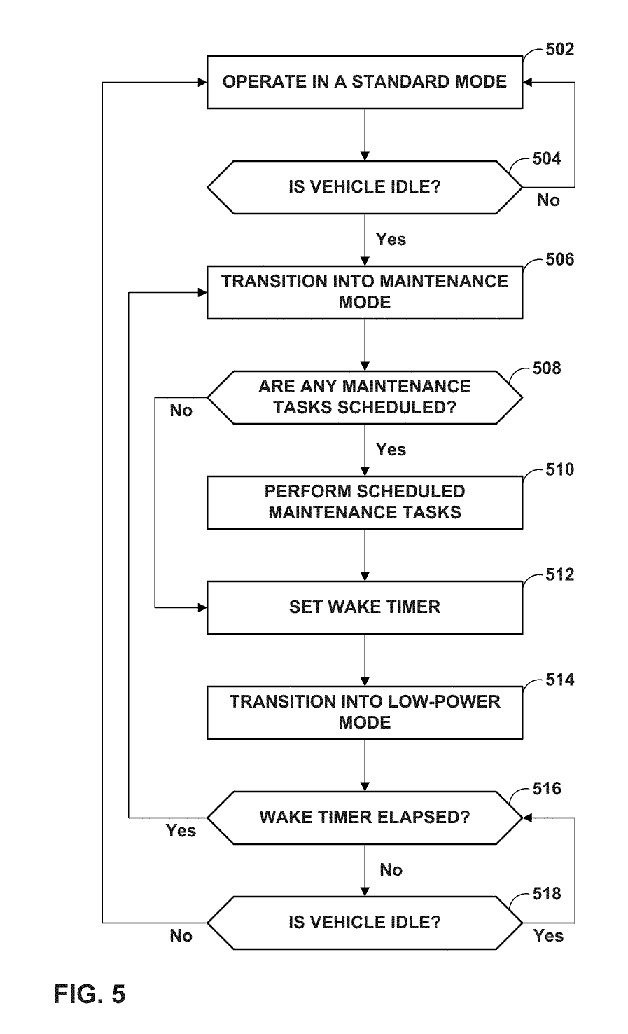

FIG. 5 is a flow diagram illustrating example operations of a vehicle computing system to perform maintenance tasks, in accordance with one or more techniques of the present disclosure. The techniques of FIG. 5 may be performed by one or more processors of a computing system, such as vehicle computing system 4 illustrated in FIG. 1 and FIG. 2. For purposes of illustration, the techniques of FIG. 5 are described within the context of vehicle computing device 4 of FIG. 1 and FIG. 2, although computing systems having configurations different than that of vehicle computing system 4 may perform the techniques of FIG. 5.

A vehicle, such as vehicle 2 of FIG. 1, which includes vehicle computing system 4 may be used for a variety of activities, such as commuting, running errands, etc. While the vehicle is being used, vehicle computing system 4 may operate in a standard mode (502). Vehicle computing system 4 may determine that the vehicle is being used based on one or more signals. For example, vehicle computing system 4 may determine that the vehicle is being used based on the vehicle being set to drive (or some other non-park gear), a starter control, such as starter control 12 of FIG. 1, being set to run, and/or an occupancy sensor indicating that a user is sitting in a seat of the vehicle. In some examples, one or more components of vehicle computing system 4 may be configured to be active while vehicle computing system 4 is operating in the standard mode. For instance, power management module 48 may be executable by processors 32 of vehicle computing system 4 to cause a display, such as presence-sensitive display 40, of vehicle computing system 4 to be on while vehicle computing system 4 is operating in the standard mode.

While the vehicle is being operated, vehicle computing system 4 may receive an indication of a maintenance task. In some examples, one or more of communication units 38 may receive the indication of the maintenance task from an external device and via a wireless communication link. Scheduling module 50 may receive the indication from communication units 38 and schedule performance of the maintenance task. In some examples, as opposed to scheduling the maintenance task for immediate performance (i.e., while the vehicle is being used), scheduling module 50 may schedule the maintenance task to be performed when the vehicle becomes idle.

Vehicle computing system 4 may determine whether the vehicle is idle (504). For instance, maintenance module 24 may monitor one or more signals to determine whether the vehicle has become idle. Some example signals that maintenance module 24 may monitor to determine whether the vehicle is idle include, but are not necessarily limited to, the vehicle being set to park, a starter control, such as starter control 12 of FIG. 1, being set to off, an occupancy sensor indicating that there are not occupants sitting in seats of the vehicle, and/or a display, such as presence-sensitive display 40, of vehicle computing system 4 being off for a threshold period of time (e.g., 30 minutes, 60 minutes, 71 minutes, 2 hours, etc.).

Where the vehicle is not determined to be idle (“No” branch of 504), vehicle computing system 4 may continue to operate in the standard mode (502). Where the vehicle is determined to be idle (“Yes” branch of 504), vehicle computing system 4 may transition into a maintenance mode (506) during which the vehicle computing system 4 is not likely to be accessed by an occupant of the vehicle. For instance, power management module 48 may output a signal that causes one or more components of vehicle computing system 4 to transition into the maintenance mode.

While operating in the maintenance mode, vehicle computing system 4 may determine whether there are any maintenance tasks scheduled (508). For instance, in response to receiving the signal from power management module 48, scheduling module 50 may determine whether there are any maintenance tasks scheduled for performance while the vehicle is idle.

If there are one or more maintenance tasks scheduled (“Yes” branch of 508), vehicle computing system 4 may perform the maintenance tasks. For instance, maintenance module 24 may facilitate performance of the maintenance tasks.

If there are no maintenance tasks scheduled (“No” branch of 508) or performance of the maintenance tasks is complete, vehicle computing system 4 may transition into a low-power mode (514). For instance, power management module 48 may output a signal that causes one or more components of vehicle computing system 4 to transition into the low-power mode. As discussed above, vehicle computing system 4 may consume a greater amount of power when operating in the maintenance mode than when operating in the low-power mode.

As discussed above, in some examples, it may not be possible for vehicle computing system 4 to determine whether one or more new maintenance tasks have become available while vehicle computing system 4 is operating in the low-power mode. However, it may be desirable for vehicle computing system 4 to perform the new maintenance tasks prior to the next use of the vehicle.

In accordance with one or more techniques of this disclosure, vehicle computing system 4 may periodically transition from the low-power mode into the maintenance mode to determine whether any new maintenance tasks are available. For instance, vehicle computing system 4 may set a wake timer (512). While operating in the low-power mode, vehicle computing system 4 may determine whether the wake timer has elapsed (516).

If the wake timer has not elapsed (“No” branch of 516), vehicle computing system 4 may remain in the low-power mode unless vehicle computing system 4 determines that the vehicle is no longer idle (“No” branch of 518), in which case vehicle computing system 4 may transition to the standard mode (502).

If the wake timer has elapsed (“Yes” branch of 516), vehicle computing system 4 may transition into the maintenance mode (506), and determine whether any new maintenance tasks are available (508). For instance, power management module 48 may output a signal that causes one or more components of vehicle computing system 4 to transition into the maintenance mode. While operating in the maintenance mode, maintenance module 24 may determine whether any new maintenance tasks are available using one or more techniques. As one example, maintenance module 24 may cause communication units 38 to output a message to one or more external components (e.g., update servers, media servers, etc.) to request an indication as to whether any maintenance tasks are available. In some examples, if one or more maintenance tasks are available, communication units 38 may receive an indication of the one or more new maintenance tasks in response to the request. For instance, communication units 38 may receive an indication that an update to operating system 46 is available.

Scheduling module 50 may receive the indication from communication units 38 and schedule performance of the one or more new maintenance tasks. As the vehicle is idle, scheduling module 50 may schedule the one or more new maintenance tasks for immediate performance. For instance, scheduling module 50 schedule the update to operating system 46 for immediate performance.

If there are one or more new maintenance tasks scheduled (“Yes” branch of 508), vehicle computing system 4 may perform the one or more new maintenance tasks. For instance, maintenance module 24 may receive an indication from scheduling module 50 that the update to operating system 46 is scheduled and facilitate performance of the update to operating system 46. In some examples, maintenance module 24 may facilitate performance of the update to operating system 46 by causing communication units 38 to download the update to operating system 46 and by facilitating installation of the update to operating system 46.

If there are no new maintenance tasks available (“No” branch of 508) or performance of the one or more new maintenance tasks is complete, vehicle computing system 4 may set a wake timer (512) and transition back into the low-power mode (514). In other words, vehicle computing system 4 may periodically transition from the low-power mode into the maintenance mode to determine whether any new maintenance tasks are available.

As discussed above, though periodically transitioning between the low-power mode and the maintenance mode may reduce the amount of power consumed by vehicle computing system 4, it may be desirable to further reduce the power consumption. For instance, if the vehicle is idle for an extended period of time (a week, a month, a year, etc.), the amount of power consumed by vehicle computing system 4 while periodically operating in the maintenance mode may still cause a power source of the vehicle, such as power source 30 of vehicle 2 of FIG. 1, to not have enough power to enable functionality of one or more components of the vehicle when use of the vehicle is next desired.

In accordance with one or more techniques of this disclosure, as opposed to always setting the wake time for the same duration, vehicle computing system 4 may occasionally increase the duration at-which the wake timer is set. For instance, during a first period of time that the vehicle is idle (e.g., one week), vehicle computing system 4 may set the wake timer to a first duration (e.g., one day). During a second period of time that the vehicle is idle (e.g., one month), vehicle computing system 4 may set the wake timer to a second duration that is longer than the first duration (e.g., one week). In some cases, after the vehicle has been idle for a long enough period of time (e.g., one month), vehicle computing system 4 may cease transitioning between the low-power mode and the maintenance mode and may remain in the low-power mode until the vehicle is no longer idle. For instance, after the vehicle has been idle for a long enough period of time, vehicle computing system 4 may transition from the maintenance mode into the-low power mode (514) without setting a wake timer. In this way, vehicle computing system 4 may reduce the amount of power consumed while the vehicle is idle while also performing new maintenance tasks without undue delay and increasing the likelihood that the power supply of the vehicle will have enough power to enable functionality of one or more components of the vehicle when use of the vehicle is next desired.

Throughout the disclosure, examples are described where an in-vehicle computing system, computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

The following numbered examples may illustrate one or more aspects of the disclosure:

### Example 1

A method comprising: responsive to determining that a vehicle that includes the in-vehicle computing system is idle, transitioning, by the in-vehicle computing system, into a maintenance mode during which the in-vehicle computing system is not likely to be accessed by an occupant of the vehicle; while operating in the maintenance mode, performing, by the in-vehicle computing system, one or more maintenance tasks; in response to determining that no maintenance tasks are scheduled or that performance of the one or more maintenance tasks are complete, transitioning, by the in-vehicle computing system, into a low-power mode, wherein the in-vehicle computing system consumes a greater amount of power when operating in the maintenance mode than when operating in the low-power mode; and periodically transitioning, by the in-vehicle computing system and from the low-power mode, into the maintenance mode to determine whether any new maintenance tasks are available.

### Example 2

The method of example 1, wherein periodically transitioning into the maintenance mode to determine whether any new maintenance tasks are available comprises: transitioning, by the in-vehicle computing system and with increasing intervals, into the maintenance mode to determine whether any new maintenance tasks are available.

### Example 3

The method of any combination of examples 1-2, further comprising: responsive to determining that a time for which the vehicle has been idle is greater than a threshold amount of time, remaining, by the in-vehicle computing system, in the low-power mode until determining that the vehicle is no longer idle.

### Example 4

The method of any combination of examples 1-3, wherein determining whether any maintenance tasks are scheduled comprises: receiving, by the in-vehicle computing system and via a wireless communication link of the vehicle, an indication of a new maintenance task.

### Example 5

The method of any combination of examples 1-4, further comprising determining that the vehicle is idle in response to one or more of: determining that a display of the in-vehicle computing system is off; determining that the vehicle is in park; and determining that a starter control of the vehicle is set to off.

### Example 6

The method of any combination of examples 1-5, wherein the maintenance tasks comprise one or both of: updating firmware or software of the in-vehicle computing system; and downloading media for use by the in-vehicle computing system.

### Example 7

An in-vehicle computing system comprising: one or more wireless communication units; and one or more processors configured to perform the method of any combination of examples 1-6.

### Example 8

An in-vehicle computing system comprising means for performing the method of any combination of examples 1-6.

### Example 9

A computer-readable storage medium storing instructions that, when executed, cause one or more processors of an in-vehicle computing system to perform the method of any combination of examples 1-6.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the invention have been described. These and other examples are within the scope of the following claims.

What is claimed is:

1. A method comprising:
responsive to determining that a vehicle that includes an in-vehicle computing system is idle, transitioning, by the in-vehicle computing system, into a maintenance mode during which the in-vehicle computing system is not likely to be accessed by an occupant of the vehicle;
while operating in the maintenance mode, performing, by the in-vehicle computing system, one or more maintenance tasks;
in response to determining that no maintenance tasks are scheduled or that performance of the one or more maintenance tasks are complete, transitioning, by the in-vehicle computing system, into a low-power mode, wherein the in-vehicle computing system consumes a greater amount of power when operating in the maintenance mode than when operating in the low-power mode; and
periodically transitioning, by the in-vehicle computing system and from the low-power mode, into the maintenance mode to determine whether any new maintenance tasks are available.

2. The method of claim 1, wherein periodically transitioning into the maintenance mode to determine whether any new maintenance tasks are available comprises:
transitioning, by the in-vehicle computing system and with increasing intervals, into the maintenance mode to determine whether any new maintenance tasks are available.

3. The method of claim 2, further comprising:
responsive to determining that a time for which the vehicle has been idle is greater than a threshold amount of time, remaining, by the in-vehicle computing system, in the low-power mode until determining that the vehicle is no longer idle.

4. The method of claim 1, wherein determining whether any maintenance tasks are scheduled comprises:
receiving, by the in-vehicle computing system and via a wireless communication link of the vehicle, an indication of a new maintenance task.

5. The method of claim 1, further comprising determining that the vehicle is idle in response to one or more of:
determining that a display of the in-vehicle computing system is off;
determining that the vehicle is in park; and
determining that a starter control of the vehicle is set to off.

6. The method of claim 1, wherein the maintenance tasks comprise one or both of:
updating firmware or software of the in-vehicle computing system; and
downloading media for use by the in-vehicle computing system.

7. An in-vehicle computing system comprising:
one or more wireless communication units; and
one or more processors configured to:
transition, responsive to determining that a vehicle that includes the in-vehicle computing system is idle, into a maintenance mode during which the in-vehicle computing system is not likely to be accessed by an occupant of the vehicle;
perform, while operating in the maintenance mode, one or more maintenance tasks;
transition, responsive to determining that no maintenance tasks are scheduled or that performance of the one or more maintenance tasks are complete, into a low-power mode, wherein the in-vehicle computing system consumes a greater amount of power when operating in the maintenance mode than when operating in the low-power mode; and
periodically transition, from the low-power mode, into the maintenance mode to determine whether any new maintenance tasks are available.

8. The in-vehicle computing system of claim 7, wherein, to periodically transition into the maintenance mode to determine whether any new maintenance tasks are available, the one or more processors are configured to:
transition, with increasing intervals, into the maintenance mode to determine whether any new maintenance tasks are available.

9. The in-vehicle computing system of claim 8, wherein the one or more processors are further configured to:
remain, responsive to determining that a time for which the vehicle has been idle is greater than a threshold amount of time, in the low-power mode until determining that the vehicle is no longer idle.

10. The in-vehicle computing system of claim 7, wherein, to determine whether any maintenance tasks are scheduled, the one or more processors are configured to:
receive, via the one or more wireless communication units, an indication of a new maintenance task.

11. The in-vehicle computing system of claim 7, wherein the one or more processors are configured to determine that the vehicle is idle in response to one or more of:
determining that a display of the in-vehicle computing system is off;
determining that the vehicle is in park; and
determining that a starter control of the vehicle is set to off.

12. The in-vehicle computing system of claim 7, wherein the maintenance tasks comprise one or both of:
updating firmware or software of the in-vehicle computing system; and
downloading media for use by the in-vehicle computing system.

13. A computer-readable storage medium storing instructions that, when executed, cause one or more processors of an in-vehicle computing system to:
transition, responsive to determining that a vehicle that includes the in-vehicle computing system is idle, into a maintenance mode during which the in-vehicle computing system is not likely to be accessed by an occupant of the vehicle;
perform, while operating in the maintenance mode, one or more maintenance tasks;
transition, responsive to determining that no maintenance tasks are scheduled or that performance of the one or more maintenance tasks are complete, into a low-power mode, wherein the in-vehicle computing system consumes a greater amount of power when operating in the maintenance mode than when operating in the low-power mode; and
periodically transition, from the low-power mode, into the maintenance mode to determine whether any new maintenance tasks are available.

14. The computer-readable storage medium of claim 13, wherein the instructions that cause the one or more processors to periodically transition into the maintenance mode to determine whether any new maintenance tasks are available comprise instructions that cause the one or more processors to:
transition, with increasing intervals, into the maintenance mode to determine whether any new maintenance tasks are available.

15. The computer-readable storage medium of claim 14, further comprising instructions that cause the one or more processors to:
remain, responsive to determining that a time for which the vehicle has been idle is greater than a threshold amount of time, in the low-power mode until determining that the vehicle is no longer idle.

16. The computer-readable storage medium of claim 13, wherein the instructions that cause the one or more processors to determine whether any maintenance tasks are scheduled comprise instructions that cause the one or more processors to:
receive, via a wireless communication link of the vehicle, an indication of a new maintenance task.

17. The computer-readable storage medium of claim 13, further comprising instructions that cause the one or more processors to determine that the vehicle is idle in response to one or more of:
a display of the in-vehicle computing system being off;
that the vehicle being in park; and
a starter control of the vehicle being set to off.

18. The computer-readable storage medium of claim 13, wherein the maintenance tasks comprise one or both of:
updating firmware or software of the in-vehicle computing system; and
downloading media for use by the in-vehicle computing system.
